(19) United States
(12) Patent Application Publication
(10) Pub. No.: US 2005/0008211 A1
(43) Pub. Date: Jan. 13, 2005

(54) Lung contrast normalization on direct digital and digitized chest images for computer-aided detection (CAD) of early-stage lung cancer

(75) Inventors: Xin-Wei Xu, Gaithersburg, MD (US); Fleming Y. -M. Lure, Potomac, MD (US); H. -Y. Michael Yeh, Potomac, MD (US); Jyh-Shyan Lin, Potomac, MD (US); Ruiping Li, Rockville, MD (US); Edward A. Martello, Glenwood, MD (US)

Correspondence Address: VENABLE, BAETJER, HOWARD AND CIVILETTI, LLP, P.O. BOX 34385, WASHINGTON, DC, 20043-9998, US

(73) Assignee: Deus Technologies, LLC, Rockville, MD (US)

(21) Appl. No.: 10/883,740

(22) Filed: Jul. 6, 2004

Related U.S. Application Data
(60) Provisional application No. 60/484,653, filed on Jul. 7, 2003.

(51) Int. Cl. G06K 9/00; G06K 9/40

(52) U.S. Cl. 382/132; 382/254

(57) ABSTRACT

A method of processing x-ray images in digital form comprises: (a) inputting an x-ray image in digital form; (b) determining one or more normalization factors based on the pixels of the input x-ray image; (c) performing normalization on the input x-ray image by applying the one or more normalization factors to the pixels; and (d) outputting a normalized digital x-ray image.

### CROSS-REFERENCE TO RELATED APPLICATION

This application draws priority from U.S. Provisional Patent Application No. 60/484,653, entitled, “Lung Contrast Normalization on Direct Digital and Digitized Chest Images for Computer-Aided Detection (CAD) of Early-Stage Lung Cancer,” filed on Jul. 7, 2003, and incorporated by reference herein in its entirety.

### FIELD OF THE INVENTION

The present invention is directed to computer-aided diagnosis techniques for detecting lung cancers based on digital or digitized images. More specifically, the present invention addresses normalization techniques used in adjusting contrast in such images.

### BACKGROUND OF THE INVENTION

Lung cancer is the leading cause of all cancer death in United States as well as worldwide. Nevertheless, it is generally expected that the early detection of asymptomatic lung cancers, when followed by prompt treatment, can prolong patient survival and increase the possibility for improvement of the cure rate. Over the past half century, many studies showed that radiologists overlook as many as 30% of lung nodules in routine diagnosis, even though many of the nodules can actually be visible in retrospect. Advanced image processing techniques and state-of-the-art computer-aided detection (CAD) are demonstrating their great usefulness in helping radiologists in their clinical practice to detect more cancers earlier. The RapidScreen RS-2000 (TM) system, developed by Deus Technologies, LLC, is a commercially available computer-aided detection (CAD) system for automated detection of early-stage lung cancer on digitized PA (posterior-anterior) or AP (anterior-posterior) frontal chest images. This system is film-based, and the digital chest images are typically obtained from a charge-coupled device (CCD) film scanner.

Although films are still widely used in radiological practices and procedures worldwide, more and more hospitals and clinics in the United States, Europe, and Japan are moving from film-based to filmless operations. This change has been driven by technologists' use of CR (Computer Radiography) and DR (Digital Radiography) systems to acquire radiographic examinations and store them to a PACS (Picture Archive and Communication System) and radiologists' corresponding use of networks and review stations to make diagnoses. Filmless radiology provides an ideal and streamlined environment for applying CAD technologies and systems to help radiologists improve their diagnosis accuracy and efficiency. In order to apply, for example, the RapidScreen RS-2000 (TM) technology and system to direct digital PA or AP frontal chest images obtained by CR, DR, or retrieved PACS, it is necessary to verify that the detection performance for lung nodules on these direct digital frontal chest images is not inferior to that on images digitized from films through the CCD film scanner.

Currently, there are several medical imaging device companies that manufacture and market a number of CR and DR chest imaging systems. Although CR and DR imaging systems typically have a much larger exposure dynamic range than conventional screen-film systems, the digital chest images of PA or AP and corresponding lateral views are post-processed, displayed, and stored in film-like form in order for radiologists to read them and make diagnoses. Generally, the properties of these digital but film-like chest images acquired from different CR or DR systems vary significantly in terms of pixel resolution (i.e., pixel size in millimeters), gray scale depth (maximum pixel value bits) of each pixel, and image contrast. This is due to the fact that various manufacturers use their own proprietary post-processing methods and techniques to generate the corresponding film-like chest images. FIG. 8 shows some key image properties of the film-like chest images from a few major medical imaging device companies. Two types of film scanners are typically used: CCD and laser. Because of the intrinsic differences and mechanical designs, the pixel resolutions, image contrasts, etc., are also typically different.

In order for the nodule detection algorithms of a CAD system like the RapidScreen RS-2000 (TM) system to deal with varieties of frontal chest images and obtain similar detection performance (in terms of sensitivity and false positives per each image), the digital images have to be pre-processed for normalization to make them as similar as possible, regardless of the acquisition methods of the digital images. What would be desirable would be a pre-processing method/system that performs such normalization.

### SUMMARY OF THE INVENTION

The present invention cures the above-mentioned deficiencies of the prior art by providing a uniform normalization method to pre-process the digitized images scanned from various film scanners and original CR and DR digital chest images prior to performing CAD techniques on them.

In one embodiment of the invention, a method of processing x-ray images in digital form comprises the steps of: (a) inputting an x-ray image in digital form; (b) determining one or more normalization factors based on the pixels of the input x-ray image; (c) performing normalization on the input x-ray image by applying the one or more normalization factors to the pixels; and (d) outputting a normalized digital x-ray image.

In a further embodiment of the invention, the method is embodied in the form of software on a computer-readable medium. In yet a further embodiment of the invention, the computer-readable medium, containing software embodying the method, is part of a computer system.

Applicable Definitions

In describing the invention, the following definitions are applicable throughout (including above).

A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a microcomputer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk, like a CD-ROM or a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: code segments; instructions; computer programs; and programmed logic.

A “computer system” refers to a system having a computer, where the computer comprises a computer-readable medium embodying software to operate the computer.

### BRIEF DESCRIPTION OF THE DRAWINGS

The invention is now described in further detail with reference to the accompanying drawings, in which:

FIGS. 1(a)-1(f) show output images from various imaging sources;

FIG. 2 shows the selection of a rectangular region of interest (ROI) at the center of a chest image;

FIGS. 3(a)-3(f) show the images of FIGS. 1(a)-1(f) following processing using the CPVN process without windowing;

FIGS. 4(a)-4(f) show the images of FIGS. 1(a)-1(f) following processing using the PVGSN process without windowing;

FIGS. 5(a) and 5(b) show signatures obtained from the corresponding horizontal and vertical lines, respectively, shown in FIG. 2;

FIG. 6 shows a scatter plot of average horizontal signature contrast versus average vertical signature contrast for images using PVGSN processing;

FIG. 7 shows a scatter plot of average horizontal signature contrast versus average vertical signature contrast for images using CPVN processing;

FIG. 8 is a table showing some image properties of various CR and DR chest images;

FIG. 9 is a table listing normalization factors for PVGSN processing;

FIG. 10 is a table giving results of Student-t tests on average signature contrast with PVGSN processing for chest images from screen-film, CR, and DR;

FIG. 11 is a table giving results of Student-t tests on average signature contrast with CPVN processing for chest images from screen-film, CR, and DR;

FIG. 12 is a table giving typical performance results for various images using CPVN or PVGSN processing;

FIG. 13 shows a basic block diagram of the inventive method; and

FIG. 14 shows an exemplary computer system that may be used to implement some embodiments of the invention.

### DETAILED DESCRIPTION OF VARIOUS EMBODIMENTS

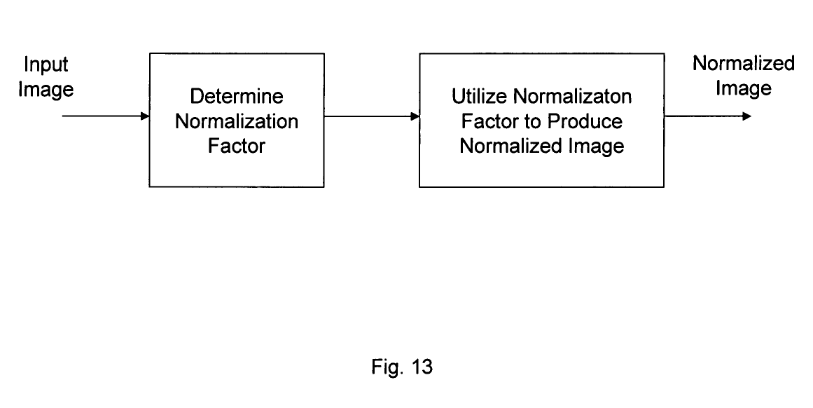

The present invention involves the processing of an input digital (or digitized) x-ray image to create a normalized image of appropriate format. FIG. 13 shows a conceptual block diagram of the steps of this process. In general, an input image is processed to determine a normalization factor. The normalization factor may also involve parameters of the target system (e.g., number of values, desired resolution, or the like). The normalization factor is then applied to the input image to obtain a normalized output image. The normalized image may then undergo further processing and/or display on a display device. The further processing may include a second stage of normalization, according to the principles of the present invention.

Lung nodule detection algorithms of a CAD system will typically require some given gray value depth and pixel resolution. For example, the lung nodule detection algorithms of the RapidScreen RS-2000 (TM) system, which will be used as an exemplary system throughout this description (but to which the present invention is not limited) require that the input frontal digital chest image have a 10-bit gray value depth (i.e., each pixel with pixel value ranging from 0 to 1023) and the pixel resolution (pixel size) around 0.7 mm (i.e., each pixel representing 0.7 mm in size). It should be noted that the smallest size of nodule that could be detected by the RapidScreen RS-2000 (TM) system is about 5 mm in diameter, which is about 7 times larger than the required pixel resolution (0.7 mm in size) of the input chest images. The current film-based RapidScreen RS-2000 (TM) system, using a CCD film scanner, is used to generate a baseline digital chest image from the 14″×17″ film with 150 dpi (or pixel size of 0.167 mm for each dot pixel) resolution and 16-bit gray scale depth (pixel value ranging from 0 to 65535). The image matrix size of the original scanned image is 2100×2550 (2 k×2 k). Thus, the original image size is reduced by a factor of four to a basic input image requirement 525×637 with the corresponding pixel resolution increased to 0.67 mm. This image matrix size reduction or pixel size increase is used to reduce computing time and to avoid the false positives resulting from some fine vessel structures.

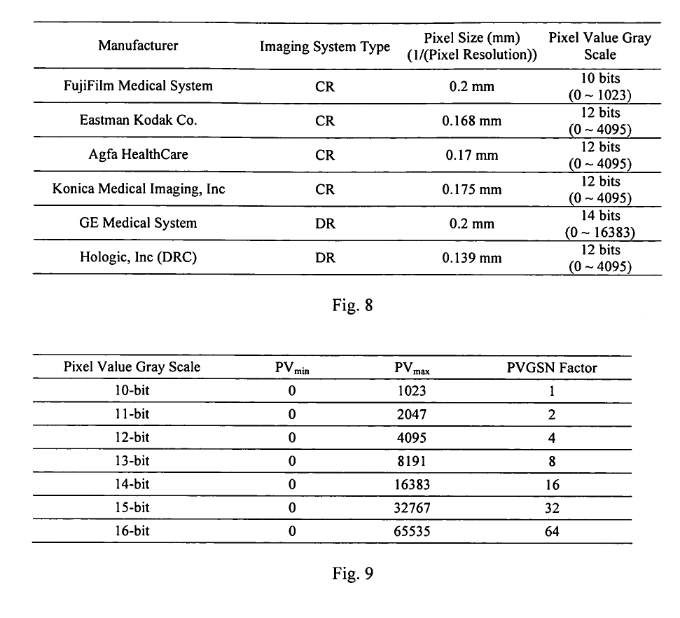

FIG. 8 shows that the pixel size of digitized, original digital CR, and DR chest images is usually much smaller than 0.7 mm. It should be noted that the pixel resolution is inversely proportional to the pixel size, i.e., the smaller the pixel size in millimeters, the higher the pixel resolution. To perform pixel resolution normalization (PRN), a first type of normalization according to the present invention, one first determines the image matrix size reduction factor (RF), a first type of normalization factor. The RF is an integer that is derived by taking the ratio of 0.7 (for the exemplary system) over the pixel size in millimeters of the original digital chest image and truncating the decimals. Thus, one can reduce the matrix size of the original CR and DR digital chest image by the factor of RF. In the reduced image the pixel value of each pixel is the average value from a square in RF×RF at the corresponding pixel in the original image. The pixel size in millimeters of the reduced chest image is thus equal to the product of the original pixel size and RF. This pixel resolution normalization (PRN) method is also defined here as the image size averaging reduction.

In addition to the reduction of computing time and false positives due to the fine vessel structures mentioned above, the image size averaging reduction method can also remove some noise pixels in the original CR and DR chest images. These noise pixels may cause repeatability problems for algorithms that detect lung nodules in chest images. As an example for the PRN, a DR PA chest image from Hologic Inc., in Bedford, Mass. has a pixel size of 0.139 mm with image matrix of 2560 (width)×3072 (height) pixels. The RF is thus obtained as 0.7/0.139=5. Therefore, the normalized pixel size is 5·0.139=0.695 mm and the corresponding reduced matrix size of the image for input to the detection algorithms is 640×768. The pixel value of each pixel of the reduced input image is obtained from the average of these pixel values within the corresponding 5×5 square-box in the original DR PA chest image.

Digital x-ray images may also, or alternatively, be normalized according to the actual values of the pixels, to achieve a desired range of pixel values (i.e., image contrast). The original raw digital chest images generated from CR and DR systems have a linear response between gray scale values and x-ray exposures of a much wider dynamic range than for film-based systems. However, a logarithmic conversion is usually applied to transfer the raw images to their film-like version for radiologists to read and make diagnoses. The converted, film-like digital chest images produced from different CR and DR systems thus have different properties, as shown in FIG. 8. As a result, the image contrast varies greatly among the images generated by the various systems. This is mainly because the corresponding manufacturers apply their own proprietary image acquisition technologies, post-image processing methods, and unique conversion look-up tables (LUTs). Similar image characteristics also appear for different types of scanners, namely CCD-based and laser-based scanners.

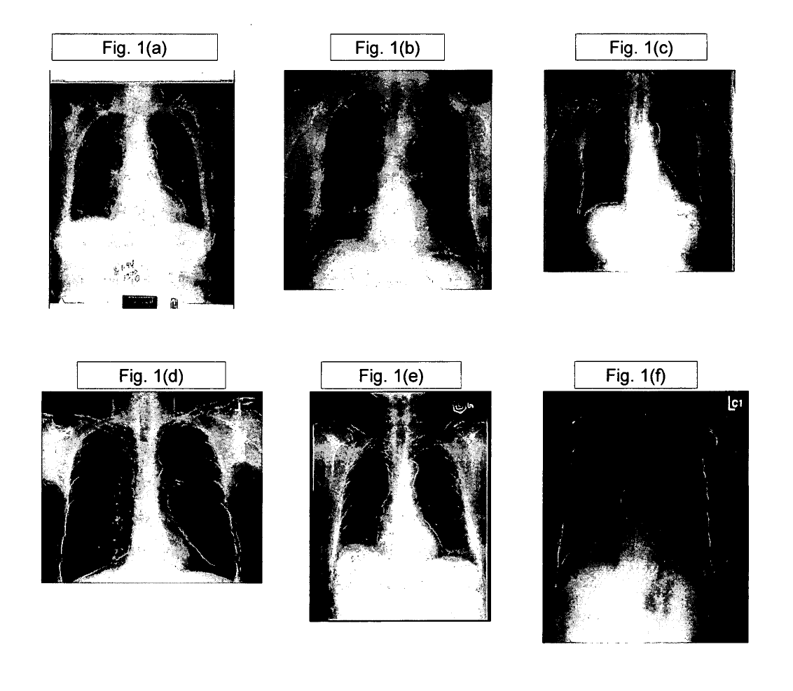

FIGS. 1(b)-1(f) display the appearances of five CR and DR film-like chest images without applying any windowing operation. Specifically, FIG. 1(b) represents a 10-bit gray scale depth image generated by a FujiFilm system; FIG. 1(c) represents a 12-bit image generated by an Agfa system; FIG. 1(d) represents a 12-bit image generated by a Kodak system; FIG. 1(e) represents a 12-bit image generated by a Hologic, Inc., system; and FIG. 1(f) represents a 14-bit image generated by a GE Medical Systems system. For comparison, the digital image of a PA chest film derived from a CCD film scanner of a type that could be used with the RapidScreen RS-2000 (TM) system is also included in FIG. 1(a) as a baseline comparison; the gray scale depth of this image is 16 bits. It is clearly demonstrated in FIGS. 1(a)-1(f) that the chest image contrast (mainly the differences of pixel values between lung regions and mediastinal and upper diaphragm regions) varies greatly among these images. The images in FIGS. 1(a)-1(c) appear to have less contrast than those in FIGS. 1(d)-1(f). It is also noted that the pixel value gray scale depth changes across these original images, i.e., from 10-bit (0˜1023) to 16-bit (0˜65535).

As indicated in the previous section, the nodule detection algorithms of the exemplary RapidScreen RS-2000 (TM) system require that the input images have a gray scale depth of 10 bits. In addition, the nodule detection performance is vulnerable to the large variations in image contrast among digital chest images resulting from different CR and DR imaging systems. Therefore, in order to maintain the generalization of nodule detection performance over CR, DR, and film-scanned digital images, it is desirable to develop a uniform pixel value normalization method that is effective for digital images from any system, of any manufacturer. One pixel value normalization according to the invention is defined as contrast pixel value normalization (CPVN) and is described in detail in the following paragraph.

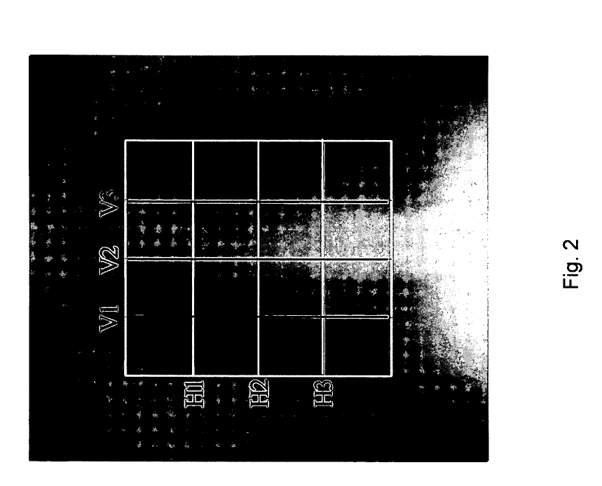

FIG. 2 shows a 10-bit digital PA chest image from a CR system manufactured by FujiFilm Medical System after PRN. The RF factor is 3 for this digital CR chest image, and the image matrix size and the effective pixel size are 587×587 and 0.6 mm, respectively. However, the corresponding sizes before PRN are 1760×1760 and 0.2 mm, respectively. In order to perform contrast pixel value normalization (CPVN), it is useful to estimate the lung contrast (LC) of the original chest image. In this study, the lung contrast (LC) is directly related to the differences between pixel values inside the lungs and those in the mediastinal and upper diaphragm regions. To obtain the LC, one first places a general rectangular box (region of interest, ROI) at the center of the chest image, as shown in FIG. 2. The width and height of this general rectangular ROI are, for example, set to 80% of the image width and height, respectively. For an adult PA chest image without position errors, this rectangular ROI will generally cover most lung areas, as well as the mediastinal, heart, and part of upper diaphragm regions. The minimum pixel value (PVₘᵢₙ) inside the ROI is usually located at the lungs. However, the corresponding maximum pixel value (PVₘₐₓ) can be found among the mediastinal, heart, and part of upper diaphragm regions. We define the LC as the difference between the maximum pixel value (PVₘₐₓ) and the minimum pixel value (PVₘᵢₙ). Thus, we can further define the normalization factor for CPVN (Factor_{CPVN}) as

$${Factor}_{CPVN} = \frac{{PV}_{max} - {PV}_{min} + 1}{1024} . \qquad ( 1 )$$

Note that the denominator value is 1024 for the 10-bit resolution of the exemplary RapidScreen RS-2000 (TM) system, but it may vary in systems of varying resolutions, as would be known to one skilled in the art.

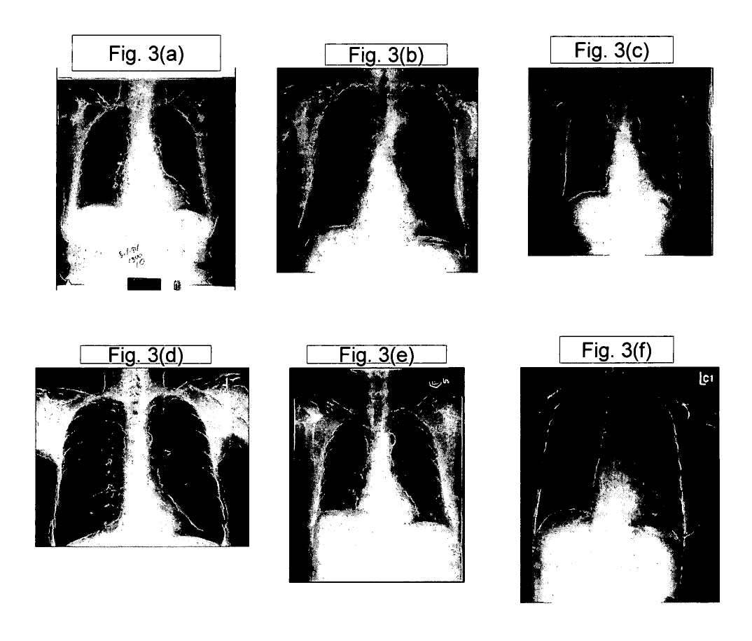

Let PV_{CPVN}(i,j) denote the integer value of the pixel element at line i and row j of the image matrix after CPVN, and the PV_{orig}(ij) be the corresponding pixel value in the original input image matrix. Then the PV_{CPVN}(ij) can be expressed by

$${PV}_{CPVN} ( i , j ) = \frac{{PV}_{orig} ( i , j ) - {PV}_{min}}{{Factor}_{CPVN}} , \qquad ( 2 )$$

where i=0,1,2,3, . . . w−1, and j=0,1,2,3, . . . h−1. The w and h represent the width and height, in pixels, of the input image, respectively. It should be noted that for an input image, the pixel values range depends on the gray scale depth, as shown in the fourth column of FIG. 8. After CPVN, however, PV_{CPVN}s have a range only from 0 to 1023, i.e., 10-bit gray scale depth. FIGS. 3(a)-3(f) illustrate the CPVN results for the images shown in FIGS. 1(a)-1(f). In comparison with FIGS. 1(a)-1(f), the images in FIGS. 3(a)-3(f) are of 10-bit gray scale depth and have much uniform image contrast across different imaging systems. The CPVN is advantageous for the nodule detection algorithms of the exemplary RapidScreen RS-2000 (TM) system, in that CPVN allows the system to perform on any digital PA or AP chest images and to maintain favorable detection performance.

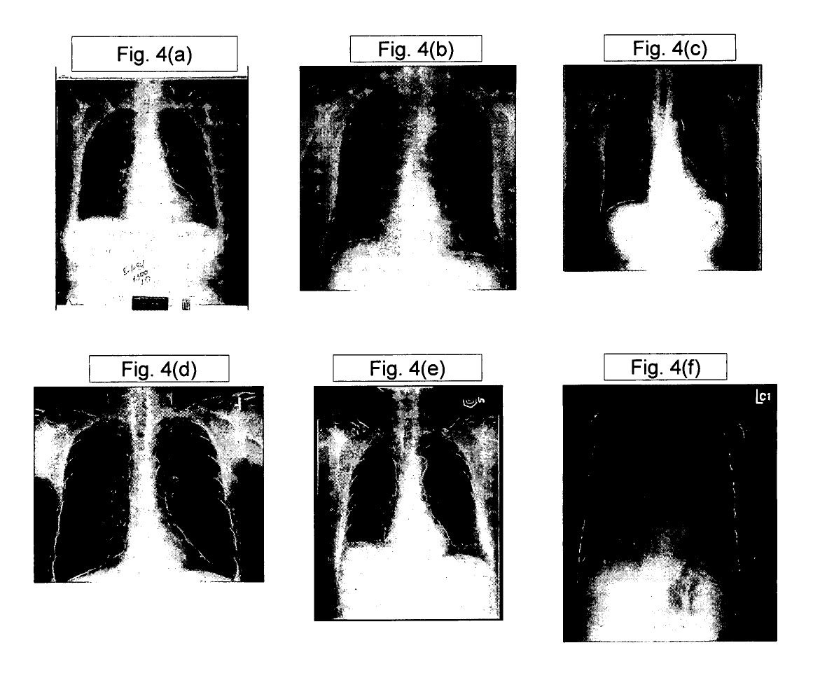

If the PVₘᵢₙ and PVₘₐₓ are taken according to the minimum and maximum values of the input image gray scale depth, instead of the values obtained from the rectangular ROI at the center of the image, the CPVN becomes the pixel value gray scale normalization (PVGSN). The pixel value gray scale normalization (PVGSN) will normalize pixel values to a 10-bit gray scale without any modification of image contrast, as shown in FIGS. 4(a)-4(f), which, again, correspond to the respective images of FIGS. 1(a)-1(f). Therefore, nodule detection performance on the input images after PVGSN deteriorates seriously for digital CR and DR chest images obtained from different imaging systems, as will be discussed further below. In other words, when applying PVGSN instead of CPVN, performance of detection results on images obtained from various CRs, DRs, and various film scanners decreases significantly. FIG. 9 lists the normalization factor of PVGSN for the gray scale depth from 10-bit to 16-bit digital images.

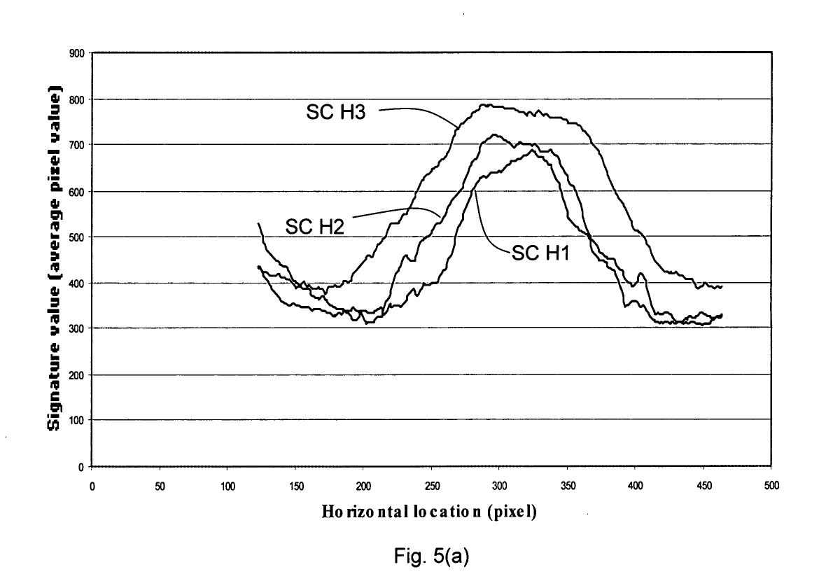

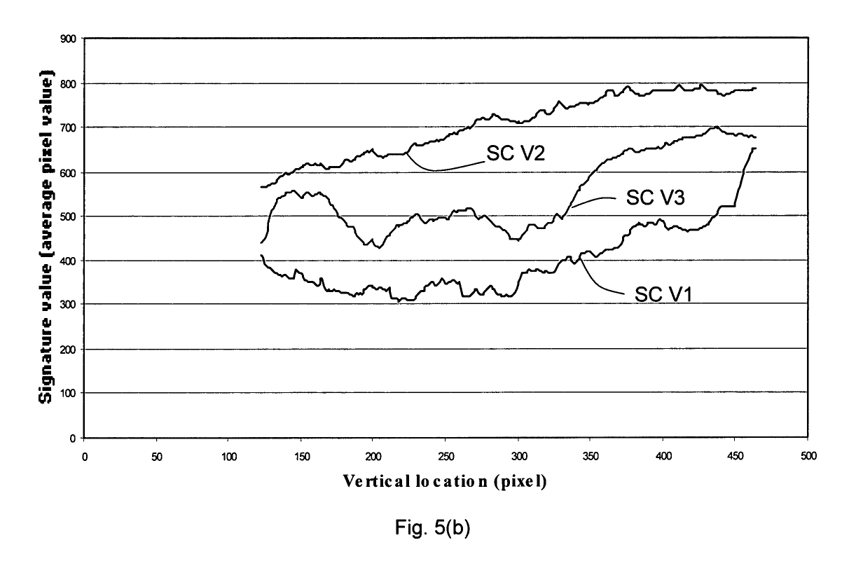

To quantitatively evaluate the effectiveness of CPVN on image contrast normalization, we introduce the concept of signature contrast (SC). As shown in FIG. 2, three horizontal lines and three vertical lines are chosen, equally spaced within the rectangular ROI; note that three is taken as an exemplary implementation, but the invention is not thusly limited. The signatures of the horizontal and vertical lines, which represent the variation of the average pixel value along these lines, are shown in FIGS. 5(a) and 5(b), respectively. The difference between the maximum and minimum value along the signature is defined as the signature contrast (SC). The maximum value along a horizontal signature is usually located at the mediastinal region. On the other hand, the maximum value of a vertical signature can typically be found in the mediastinal as well as the upper diaphragm areas. However, the minimum values of both horizontal and vertical signatures are generally obtained inside left or right lungs. The SC is thus closely related to the LC defined previously.

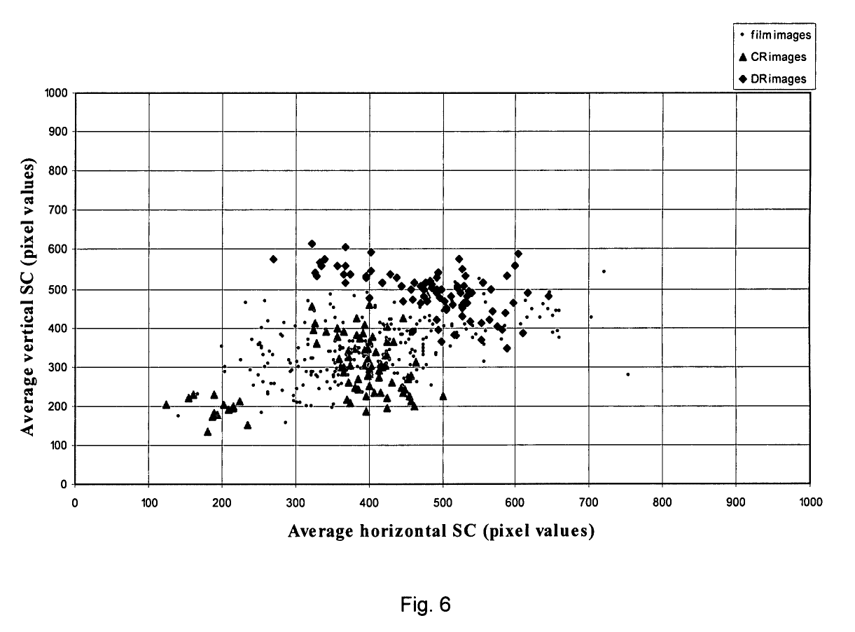

FIG. 6 is a scatter plot of the average horizontal SC versus the average vertical SC for 247 film-scanned, 84 CR and 84 DR digital PA chest images with PVGSN processing. The data points for DR images, which were all from one manufacturer, have relative higher average horizontal and vertical SCs. For CR images, 15 of 84 images are from one manufacturer, with lower horizontal and vertical SCs of around 200. However, the remaining 69 CR images are from a second manufacturer whose horizontal and vertical SCs are around 400 and 300, respectively. The 247 films were collected from multiple institutions of different countries, and their horizontal and vertical SCs have a much larger variation compared with that from CR and DR images. This is understandable because the image quality of films relies mainly on the screen-film system used, quality control procedures, and chemical processes. It is clearly indicated in FIG. 6 that the contrast variation is very significant among digital images from multiple sources, unless one uses appropriate normalization methods to make corrections.

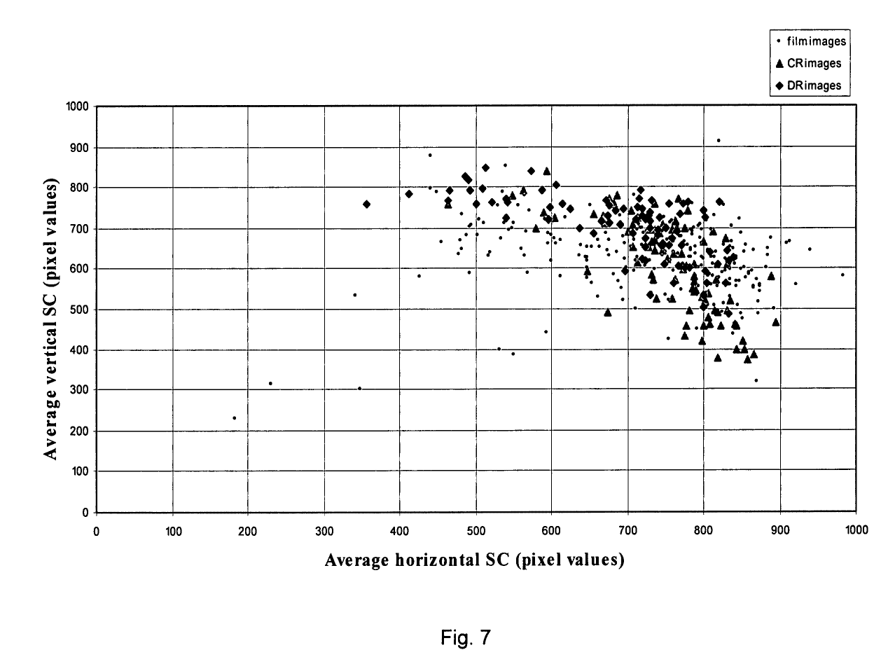

FIG. 7 is a similar scatter plot for the same sets of images using CPVN processing. The average horizontal and vertical SCs of film-scanned, CR, and DR digital chest images are now largely overlapped. This means that the LCs of these images obtained from different sources are more uniform after CPVN. This result is consistent with the observation of FIGS. 3(a)-3(f).

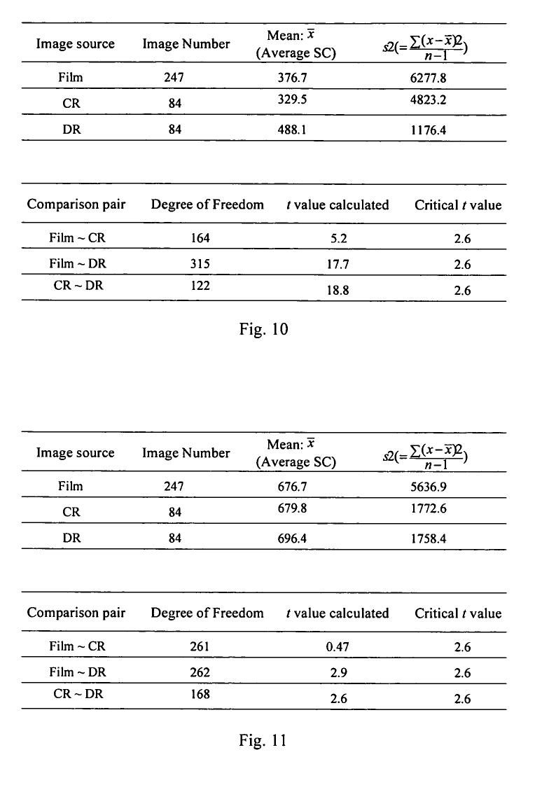

To further demonstrate the effectiveness of CPVN on LC normalization for multiple sources of digital chest images, we can perform a Student-t test to the null hypothesis on the average SCs. Here, the average SC is defined as the average value of the average horizontal SC and average vertical SC. The null hypothesis is that there is no difference in the average SC among digital chest images from various sources. For the image sets used for FIGS. 6 and 7, the calculated t values (in the Student-t test) with PVGSN and CPVN are shown in FIGS. 10 and 11, respectively. It is seen in FIG. 10 that the calculated t values for all pairs of image sources are much larger than the critical t value, at the 99% confidence level. Therefore, the null hypothesis is rejected for digital images with PVGSN because the LCs of various digital chest images are largely deviated. However, the null hypothesis is more acceptable for digital images from various sources with CPVN, since the calculated t values for all comparison pairs are smaller or close to the critical t value, as shown in FIG. 11.

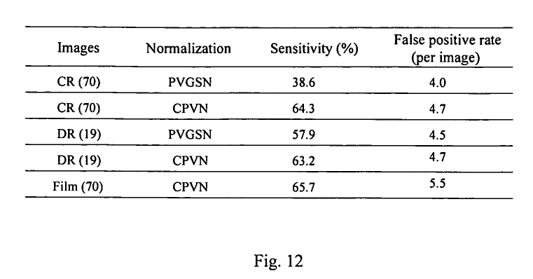

FIG. 12 compares the nodule detection performance on direct digital CR and DR chest images with different normalization methods. The nodule detection algorithm used was the CAD detection engine in the RapidScreen RS-2000 (TM) system. The 70 CR chest images are from FujiFilm CR systems, and the 19 DR chest images are from GE DR systems. For comparison purposes, the detection performance on 72 films is also included. For the DR images from GE DR systems, the detection performance is close for both normalization methods. This is mainly because the post-conversion LUT from GE DR systems produces the chest image with higher image contrast. Therefore, the CPVN process does not modify the image contrast a lot for the GE DR images. On the other hand, the detection performance for the set of Fuji CR images with PVGSN is much worse (the sensitivity drops almost 35% at a comparable level of false positive rate). With the use of CPVN, the detection performance on Fuji CR images is comparable to that on films.

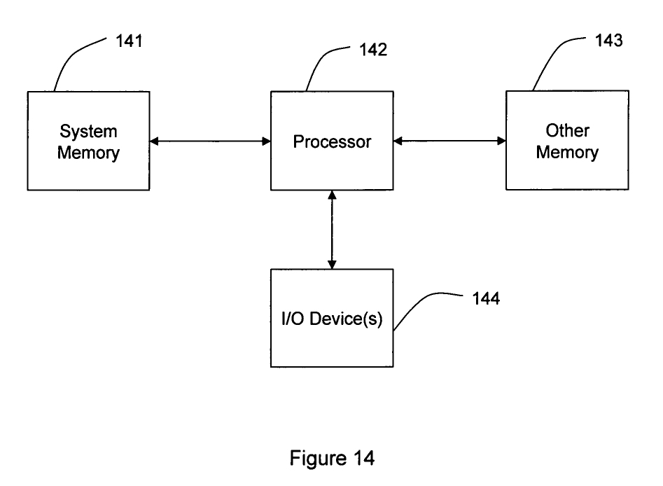

Some embodiments of the invention may be embodied in the form of software instructions on a machine-readable medium. Such an embodiment is illustrated in FIG. 14. The computer system of FIG. 14 may include at least one processor 142, with associated system memory 141, which may store, for example, operating system software and the like. The system may further include additional memory 143, which may, for example, include software instructions to perform various applications. The system may also include one or more input/output (I/O) devices 144, for example (but not limited to), keyboard, mouse, trackball, printer, display, network connection, etc. The present invention may be embodied as software instructions that may be stored in system memory 141 or in additional memory 143. Such software instructions may also be stored in removable or remote media (for example, but not limited to, compact disks, floppy disks, etc.), which may be read through an I/O device 143 (for example, but not limited to, a floppy disk drive). Furthermore, the software instructions may also be transmitted to the computer system via an I/O device 143, for example, a network connection; in such a case, a signal containing the software instructions may be considered to be a machine-readable medium.

Digital images from various imaging systems can have different image properties such as pixel resolution, gray scale depth and image contrast. It is likely that these differences will greatly affect the performance of CAD algorithms that are typically trained and tested by one type of image source. The present invention provides an effective uniform image normalization method (CPVN) that can minimize these differences in the image properties. Nodule detection CAD algorithms achieve a high level of generalization for digital images from multiple sources of imaging systems.

As mentioned above, the specific embodiments above are described in the context of the exemplary RapidScreen RS-2000 (TM) system. However, the invention is not to be understood as being limited to such embodiments, and it would be well within the understanding of one of ordinary skill in the art to make the associated adjustments in the invention. For example, as discussed above, the RapidScreen RS-2000 (TM) system uses 10-bit resolution. However, other systems may use other resolutions, and it is to be understood that the invention is equivalently applicable to such systems.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. A method of processing x-ray images in digital form, the method comprising:
inputting an x-ray image in digital form;
determining a first normalization factor, N, based on a pixel size of the input x-ray image;
determining a second normalization factor, K, based on one or more pixel values of the input x-ray image;
performing normalization on the input x-ray image by applying the normalization factors, K and N, to the pixels of the input x-ray image; and
outputting a normalized digital x-ray image.

2. The method according to claim 1, wherein said determining a normalization factor, N, comprises:
determining an input pixel size of the pixels of the input x-ray image; and
dividing a target pixel size by the input pixel size to determine the normalization factor, N;
and wherein said performing normalization comprises adjusting a resolution of the input x-ray image according to the normalization factor, N, to obtain an adjusted-resolution x-ray image.

3. The method according to claim 2, wherein said adjusting the resolution comprises:
considering N×N blocks of pixels in the input x-ray image;
for each N×N block of pixels, computing an average value of the pixel values in the block; and
defining an adjusted-resolution pixel value for the block to have the average value.

4. The method according to claim 2, wherein said determining a second normalization factor, K, comprises:
finding a maximum pixel value over the adjusted-resolution x-ray image;
finding a minimum pixel value over the adjusted-resolution x-ray image; and
computing said second normalization factor, K, based on the maximum and minimum pixel values.

5. The method according to claim 4, wherein said computing the second normalization factor, K, comprises:
computing a difference between the maximum and minimum pixel values and adding one to the difference to determine a numerator; and
dividing the numerator by a desired total number of possible pixel values.

6. The method according to claim 4, wherein each pixel value comprises a gray-scale value.

7. The method according to claim 4, further comprising:
subtracting from each pixel value of the adjusted-resolution x-ray image the minimum pixel value to determine a difference; and
dividing the difference by the second normalization factor, K, to obtain a normalized pixel value.

8. The method according to claim 1, wherein said determining a second normalization factor, K, comprises:
finding a maximum pixel value over the input x-ray image;
finding a minimum pixel value over the input x-ray image; and
computing the second normalization factor, K, based on the maximum and minimum pixel values.

9. The method according to claim 8, wherein said computing the second normalization factor, K, comprises:
computing a difference between the maximum and minimum pixel values and adding one to the difference to determine a numerator; and
dividing the numerator by a desired total number of possible pixel values.

10. The method according to claim 8, wherein each pixel value comprises a gray-scale value.

11. The method according to claim 8, wherein said performing normalization comprises:
subtracting from each pixel value of the input x-ray image the minimum pixel value to determine a difference; and
dividing the difference by the second normalization factor, K, to obtain a normalized pixel value.

12. A computer-readable medium containing software implementing the method according to claim 1.

13. A computer system comprising:
a processor; and
the computer-readable medium according to claim 12.

14. The computer system according to claim 13, further comprising means for receiving x-ray images in digital form.

15. The computer system according to claim 13, further comprising means for displaying the normalized digital x-ray image.
